(19) United States
(12) Patent Application Publication
(10) Pub. No.: US 2025/0319622 A1
(43) Pub. Date: Oct. 16, 2025

(54) CUTTING DEVICE FOR MANUFACTURING LEAD TABS OF SECONDARY BATTERY

(71) Applicant: POLE Co, Ltd., Chungcheongbuk-do (KR)

(72) Inventors: Ji Ho KIM, Chungcheongbuk-do (KR); Hyun Min LEE, Gyeonggi-do (KR); Seong Goo KIM, Chungcheongbuk-do (KR); Yoon PARK, Gyeonggi-do (KR)

(21) Appl. No.: 18/865,958

(22) PCT Filed: May 16, 2023
(86) PCT No.: PCT/KR2023/006576

§ 371 Date: Nov. 14, 2024

(30) Foreign Application Priority Data
May 16, 2022 (KR) 10-2022-0059417

(51) Int. Cl. B26F 1/44; H01M 50/533

(52) U.S. Cl. CPC B26F 1/44; H01M 50/533; B26F 2001/4427

(57) ABSTRACT

A cutting device for manufacturing lead tabs of a secondary battery disclosed herein cuts a band-shaped metal lead strip which is continuously supplied. The cutting device for manufacturing lead tabs of a secondary battery includes: a stud part; a punch having a blade tip integrated with the lower portion of the stud part; and a die having an upper surface, which is supplied with the metal lead strip, and a pocket, which the blade tip enters and exits when cutting the metal lead strip supplied to the upper surface. The punch and the die cut the metal lead strip to form metal terminals, and at the same time, cut the edges on both sides of the cut surface so that the edges have a smooth curvature.

### TECHNICAL FIELD

The present disclosure is installed in an automated facility for manufacturing lead tabs for a secondary battery, and particularly, to a cutting device for manufacturing lead tabs of a secondary battery, which cuts a continuously supplied band-shaped metal lead strip to form metal terminals and at the same time, cuts (R-cuts) both edges of fore-ends of the cut metal lead strips to have a smooth curvature.

### BACKGROUND ART

This section provides background information related to the present disclosure which is not necessarily prior art.

In general, a lead tab for a secondary battery is used as a connection terminal for an external circuit to drive a device or system that uses a secondary battery, and for this purpose, the lead tab is connected to an electrode of the secondary battery.

As anyone can see, these lead tabs are constituted by a square flat metal terminal and a lead film that is fused to a specific location on the metal terminal.

Meanwhile, the aforementioned lead tab is manufactured with sharp edges at the corners of the metal terminals, so there has been a problem of causing scratches on the electrodes of the secondary battery when connected to the electrodes.

Accordingly, recently, in order to solve the aforementioned problem, the sharp corners of the metal terminal are being processed into a round shape (R-cutting).

However, there was a problem that R-cutting of the sharp corners of the conventional metal terminals could not be performed within the automated facility for manufacturing lead tabs for secondary batteries, and this problem led to another problem of having to prepare separate R-cutting equipment.

### DISCLOSURE

### Technical Problem

The present disclosure provides a cutting device for manufacturing lead tabs of a secondary battery, which is installed in an automated facility for manufacturing lead tabs for a secondary battery, and which cuts a continuously supplied band-shaped metal lead strip to form metal terminals and at the same time, cuts (R-cuts) both edges of fore-ends of the cut metal lead strips to have a smooth curvature.

Further, technical objects to be achieved in the present disclosure are not limited to the aforementioned objects, and other technical objects not described above will be apparently understood to those skilled in the art from the following disclosure of the present disclosure.

### Technical Solution

This section provides a general summary of the disclosure and is not a comprehensive disclosure of its full scope or all of its features.

In order to achieve the object, according to any one aspect among various aspects which describe the present disclosure, a cutting device for manufacturing lead tabs of a secondary battery, which cuts a continuously supplied band-shaped metal lead strip, may include: a stud part; a punch having a blade tip integrated with the lower portion of the stud part; and a die having an upper surface, which is supplied with the metal lead strip, and a pocket, which the blade tip enters and exits when cutting the metal lead strip supplied to the upper surface, and the punch and the die may cut the metal lead strip to form metal terminals, and at the same time, cut the edges on both sides of the cut surface so that the edges have a smooth curvature.

In the cutting device for manufacturing lead tabs of a secondary battery according to one aspect of the present disclosure, the die and the punch may include a first fixed blade and a first movable blade which form a first cut surface orthogonal to a longitudinal direction of the metal lead strip at a fore-end side of the metal lead strip formed when cutting the metal lead strip, and second fixed blades and second movable blades which form a pair of second cut surfaces connecting both ends of the first cut surface and both sides of the metal lead strip with a smooth radius of curvature.

In the cutting device for manufacturing lead tabs of a secondary battery according to one aspect of the present disclosure, the first fixed blade and the second fixed blade may be formed via a protrusion provided on one side of the pocket, the first movable blade and the second movable blade may be formed via a sinking portion provided on one side of the blade tip, the first fixed blade may be formed at an edge where a protruding extension surface of the protrusion protruding to the other side of the pocket on one side of the pocket, and an upper surface of the protrusion meet, the second fixed blades may be formed at an edge where a protruding edge side of the protrusion extending smoothly to one side of the pocket with a curvature radius, and the upper surface of the protrusion meet at both ends of the protruding extension surface of the protrusion, the first movable blade may be formed at an edge where a sinking surface which sinks to the other side of the blade tip on one side of the blade tip, and a lower surface of the blade tip meet, and the second movable blades may be formed at an edge where a sinking edge side which smoothly extends to an edge side where one side of the blade tip and each end surface meet at both ends of the sinking surface of the protrusion, and the lower surface of the blade tip meet.

In the cutting device for manufacturing lead tabs of a secondary battery according to one aspect of the present disclosure, the die and the punch may include a third fixed blade and a third movable blade which form a third cut surface orthogonal to the longitudinal direction of the metal lead strip at one side of the metal terminal cut and formed in the metal lead strip when cutting the metal lead strip.

In the cutting device for manufacturing lead tabs of a secondary battery according to one aspect of the present disclosure, the third fixed blade may be formed at an edge where the other side of the pocket and the upper surface of the die meet, and the third movable blade may be formed at an edge where the vertical other side of the blade tip and the lower surface of the blade tip meet.

In the cutting device for manufacturing lead tabs of a secondary battery according to one aspect of the present disclosure, the cutting device for manufacturing lead tabs of a secondary battery may be installed in an automated facility which manufactures the lead tabs for the secondary battery.

### Advantageous Effects

According to the present disclosure, since both edges of fore-ends of the cut metal lead strips can cut (R-cut) to have a smooth curvature when cutting a metal lead strip for forming metal terminals, the inconvenience of having to separately perform R-cutting on the sharp corners of the metal terminal as in the past can be resolved, and thereby not only can the production efficiency according to the manufacture of the lead tab be significantly increased, but also the unit cost of the manufacture of the lead tab can be lowered.

### DESCRIPTION OF DRAWINGS

FIG. 1 is a perspective view schematically illustrating a cutting device for manufacturing lead tabs of a secondary battery according to the present disclosure.

FIG. 2 is a plan view of a die illustrated in FIG. 1.

FIG. 3 is a diagram of a blade tip of a punch illustrated in FIG. 1 as viewed from the bottom.

FIG. 4 is a diagram of cross-sections of a metal terminal and a metal lead strip cut by a cutting device for manufacturing lead tabs of a secondary battery according to the present disclosure.

### MODES OF THE INVENTION

Hereinafter, an exemplary embodiment of a cutting device for manufacturing lead tabs of a secondary battery according to the present disclosure will be described in detail with reference to the drawings.

However, it cannot be said that an exemplary embodiment of the intrinsic technical spirit of the disclosure is limited to an exemplary embodiment described below, and it is disclosed that the technical spirit includes a scope which can be easily proposed by a method of substitutions or changes for the exemplary embodiment described below based on the intrinsic technical spirit of the disclosure by those skilled in the art.

Further, since terms used below are selected for easy description, the terms are not limited to dictionary meanings and should be appropriately interpreted as meanings consistent with the technical spirit of the disclosure in order to grasp the intrinsic technical spirit of the disclosure.

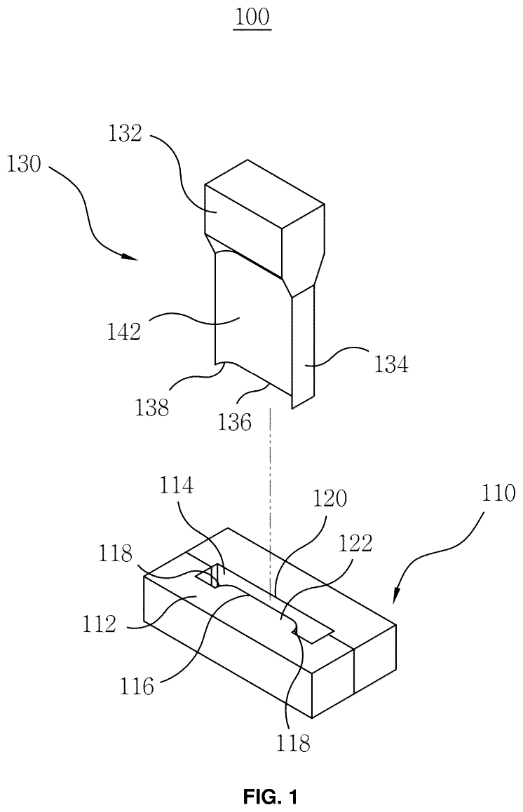

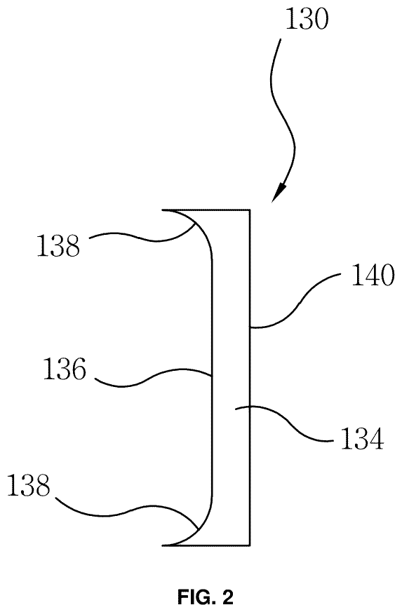

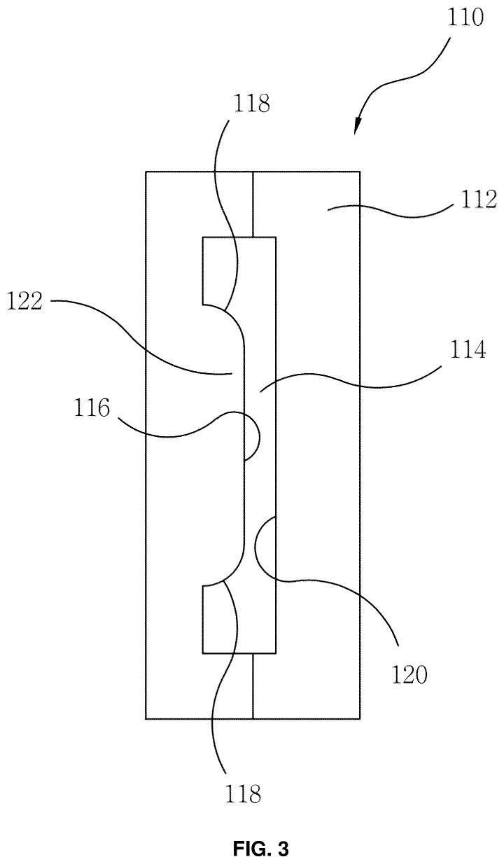

A cutting device 100 (see FIGS. 1 to 4) for manufacturing lead tabs of a secondary battery is installed in an automated facility (not illustrated) which manufactures the lead tabs for the secondary battery.

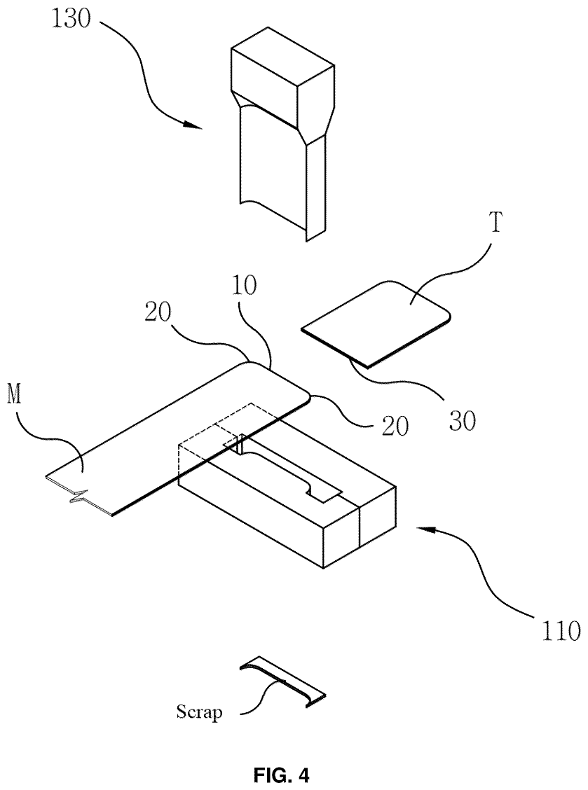

As an example, the automated facility which manufactures the lead tabs for the secondary battery includes a metal lead strip unwinding process for unwinding and supplying a metal lead strip M (see FIG. 4) in a band shape wound in a roll shape, a flattening process for flattening the surface and back surface of the supplied metal lead strip M, a cutting process for cutting (punching) the metal lead strip M along the longitudinal direction of the metal lead strip M to a preset length to manufacture metal terminals T (see FIG. 4), a lead film fusing process for manufacturing a lead tab by fusing a lead film (not illustrated) to the surface and back surface of the metal terminal, and an inspection process for inspecting the shape and dimensions of the manufactured lead tab.

As another example, the automated facility which manufactures the lead tabs for the secondary battery includes a metal lead strip unwinding process for unwinding and supplying a metal lead strip M in a band shape wound in a roll shape, a flattening process for flattening the surface and back surface of the supplied metal lead strip M, a lead film fusing process for fusing a lead film (not illustrated) on the surface and back surface of the metal lead strip M at a preset interval along the longitudinal direction of the metal lead strip M, a cutting process for cutting (punching) the metal lead strip M to which the lead film is fused along the longitudinal direction to a preset length to manufacture a lead tab, and an inspection process for inspecting the shape and dimensions of the manufactured lead tab.

Here, the cutting device 100 for manufacturing lead tabs of a secondary battery lead tab according to the present disclosure is installed in the cutting process of the various processes of the automated facility for manufacturing the lead tabs described above.

FIGS. 1 and 4 attached are diagrams schematically illustrating a cutting device for manufacturing lead tabs of a secondary battery according to the present disclosure.

Referring to FIGS. 1 to 4, a cutting device 100 for manufacturing lead tabs of a secondary battery according to the present disclosure includes a die 110 and a punch 130 that moves up and down toward the die 110, as illustrated.

The punch 130 includes a stud part 132 and a blade tip 134 integrally formed at the lower portion of the stud part 132, and the die 110 includes an upper surface 112 to which a metal lead strip M is supplied, and a pocket 114 into which the blade tip 134 of the punch 130 enters and exits when cutting the metal lead strip M supplied to the upper surface 112.

That is, the punch 130 moves up and down toward the die 110 and cuts the metal lead strip M supplied toward the upper surface 112 of the die 110, thereby forming metal terminals T.

Here, as anyone can see, the die 110 and the punch 130 are installed in a typical die set (not illustrated), and since a configuration of the die set, and lifting and lowering operations of the punch 130 installed in the die set are known technologies, a detailed description thereof is omitted.

Meanwhile, the die 110 and the punch 130 form a first cut surface 10 orthogonal to a longitudinal direction of the metal lead strip M at a fore-end side of the metal lead strip M when cutting the metal lead strip M, and a pair of second cut surfaces 20 connecting both ends of the first cut surface 10 and both sides of the metal lead strip M with a smooth radius of curvature as illustrated in FIG. 4.

Here, the fore-end side of the metal lead strip M formed during cutting forms the other side of the metal terminal T formed during cutting of the metal lead strip M, and a lead film is fused adjacent to the other side of the metal terminal T.

In addition, the die 110 and the punch 130 form a third cut surface 30 orthogonal to the longitudinal direction of the metal lead strip M on one side of the metal terminal T formed by cutting the metal lead strip M when cutting the metal lead strip M.

To this end, the die 110 and the punch 130 are each formed with a first fixed blade 116 and a first movable blade 136 that form the first cut surface 10, and a second fixed blade 118 and a second movable blade 138 that form a pair of second cut surfaces 20.

In addition, the die 110 and the punch 130 are each formed with a third fixed blade 120 and a third movable blade 140 that form the third cut surface 30.

The first fixed blade 116 and the second fixed blade 118 are formed via a protrusion 122 provided on one side of the pocket 114, and the first movable blade 136 and the second movable blade 136 are formed via a sinking portion 142 provided on one side of the blade tip 134.

As illustrated, the protrusion 122 includes a protruding extension surface protruding from one side of the pocket 114 toward the other side of the pocket 114, and protruding edge sides smoothly extending with a predetermined radius of curvature from both ends of the protruding extension surface toward one side of the pocket 114.

At this time, the first fixed blade 116 is formed at the edge where the protruding extension surface of the protrusion 122 and an upper surface of the protrusion meet, and a pair of second fixed blades 118 are formed at the edge where each of the protruding edge sides of the protrusion 122 and the upper surface of the protrusion 122 meet.

Preferably, the upper surface of the protrusion 122 is formed to be parallel with the upper surface 112 of the die 110.

In addition, as illustrated, the sinking portion 142 includes a sinking surface that sinks from one side of the blade tip 134 to the other side of the blade tip 134, and sinking edge sides that smoothly extend with a predetermined radius of curvature from both ends of the sinking surface to the edge where one side of the blade tip 134 and each end surface meet.

At this time, the first movable blade 136 is formed at the edge where the sinking surface of the sinking portion 142 and the lower surface of the blade tip 134 meet, and a pair of second movable blades 138 are formed at the edge where each of the sinking edge sides of the sinking portion 142 and the lower surface of the blade tip 134 meet.

Here, one side of the pocket 114 and one side of the blade tip 134 each mean a side adjacent to a preceding process when viewed from the preceding process among the two sides facing a supply direction of the metal lead strip M.

Meanwhile, the third fixed blade 120 is formed at the edge where the other side of the pocket 114 and the upper surface 112 of the die 110 meet, as illustrated, and the third movable blade 140 is formed at the edge where a vertical other side of the blade tip 134 and the lower surface of the blade tip 134 meet.

Here, the other side of the pocket 114 and the other side of the blade tip 134 each mean a side adjacent when viewed in a subsequent process between two sides facing the supply direction of the metal lead strip M.

The first movable blade 136, a pair of second movable blades 138, and a third movable blade 140 formed in this way maintain a preset clearance with the first fixed blade 116, a pair of second fixed blades 118, and a third fixed blade 120 and cut the metal lead strip M while entering and exiting the pocket 114 to form the metal terminals T. At this time, a third cut surface 30 is formed on one side of the metal terminal T formed by cutting by the third movable blade 140 and the third fixed blade 120, and the first cut surface 10 and a pair of second cut surfaces 20 are formed on the fore-end side of the metal lead strip M formed when cutting the metal lead strip M by the first movable blade 136 and the first fixed blade 116, and the second movable blade 138 and the second fixed blade 118.

Although it has been described above that both edges of the fore-ends of the metal lead strip M formed during cutting are R-cut, anyone can see that both edges of one side of the metal terminal T formed by cutting from the metal lead strip M may also be R-cut.

In addition, anyone can see that both edges of the fore-end of the metal lead strip M and both edges of one side of the metal terminal T may be R-cut at the same time.

1. A cutting device for manufacturing lead tabs of a secondary battery, which cuts a continuously supplied band-shaped metal lead strip, comprising:
a punch having a stud part, and a blade tip integrally at a lower portion of the stud part; and
a die having an upper surface to which the metal lead strip is supplied, and a pocket into which the blade tip of the punch enters and exits when cutting the metal lead strip supplied to the upper surface,
wherein the punch and the die cut the metal lead strip to form metal terminals, and at the same time, cut both edges of the cut surface to have a smooth curvature.

2. The cutting device for manufacturing lead tabs of a secondary battery of claim 1, wherein the die and the punch include a first fixed blade and a first movable blade which form a first cut surface orthogonal to a longitudinal direction of the metal lead strip at a fore-end side of the metal lead strip formed when cutting the metal lead strip, and second fixed blades and second movable blades which form a pair of second cut surfaces connecting both ends of the first cut surface and both sides of the metal lead strip with a smooth radius of curvature.

3. The cutting device for manufacturing lead tabs of a secondary battery of claim 2, wherein the first fixed blade and the second fixed blade are formed via a protrusion provided on one side of the pocket,
the first movable blade and the second movable blade are formed via a sinking portion provided on one side of the blade tip,
the first fixed blade is formed at an edge where a protruding extension surface of the protrusion protruding to the other side of the pocket on the one side of the pocket, and an upper surface of the protrusion meet,
the second fixed blades are formed at an edge where a protruding edge side of the protrusion extending smoothly to the one side of the pocket with a curvature radius, and the upper surface of the protrusion meet at both ends of the protruding extension surface of the protrusion,
the first movable blade is formed at an edge where a sinking surface which sinks to the other side of the blade tip on the one side of the blade tip, and a lower surface of the blade tip meet, and
the second movable blades are formed at an edge where a sinking edge side which smoothly extends to an edge side where the one side of the blade tip and each end surface meet at both ends of the sinking surface of the protrusion, and the lower surface of the blade tip meet.

4. The cutting device for manufacturing lead tabs of a secondary battery of claim 1, wherein the die and the punch include a third fixed blade and a third movable blade which form a third cut surface orthogonal to the longitudinal direction of the metal lead strip at one side of the metal terminal cut and formed in the metal lead strip when cutting the metal lead strip.

5. The cutting device for manufacturing lead tabs of a secondary battery of claim 4, wherein the third fixed blade is formed at an edge where the other side of the pocket and the upper surface of the die meet, and
the third movable blade is formed at an edge where the vertical other side of the blade tip and a lower surface of the blade tip meet.

6. The cutting device for manufacturing lead tabs of a secondary battery of claim 1, wherein the cutting device for manufacturing lead tabs of a secondary battery is installed in an automated facility which manufactures the lead tabs for the secondary battery.
